(19) United States
(12) Patent Application Publication
(10) Pub. No.: US 2014/0244000 A1
(43) Pub. Date: Aug. 28, 2014

(54) COMMUNICATION RELAY APPARATUS, OPERATION STATE DETERMINATION METHOD, COMMUNICATION RELAY CONTROL BOARD, AND RECORDING MEDIUM STORING CONTROL PROGRAM

(71) Applicant: Toshiro Yamauchi, Tokyo (JP)

(72) Inventor: Toshiro Yamauchi, Tokyo (JP)

(73) Assignee: NEC Corporation

(21) Appl. No.: 14/354,761

(22) PCT Filed: Jul. 24, 2012
(86) PCT No.: PCT/JP2012/004714

§ 371 Date: Apr. 28, 2014

(30) Foreign Application Priority Data
Oct. 28, 2011 (JP) 2011-237986

(51) Int. Cl. G05B 9/03

(52) U.S. Cl. CPC G05B 9/03
USPC 700/12

(57) ABSTRACT

A communication relay apparatus includes, in a redundant manner, a first board that holds first configuration information including latest setting information in a communication service provided while the first board itself is mounted in a given communication relay apparatus, determines its own operation state upon start-up, and changes to the determined operation state, and a second board that holds second configuration information including latest setting information in a communication service provided while the second board itself is mounted in a given communication relay apparatus, determines its own operation state upon start-up, and changes to the determined operation state, in which each of the first and second boards determines, when neither of the first and second boards is faulty and they are simultaneously started up, the own operation state based on the first and second configuration information.

### TECHNICAL FIELD

The present invention relates to a communication relay apparatus, an operation state determination method, a communication relay control board, and a control program. In particular, the present invention relates to a communication relay apparatus including a plurality of control boards mounted therein in a redundant manner, an operation state determination method, a communication relay control board, and a recording medium storing a control program.

### BACKGROUND ART

In general, a communication apparatus includes a card (control board) for controlling that communication apparatus and an interface card for transmitting data and providing a communication service. Further, each of these cards is removable. Therefore, when a certain card becomes faulty, that card can be replaced with a brand-new or second-hand card.

In recent years, the need for redundancy of control boards as well as interface cards has been increasing. Therefore, for example, when the control board is made redundant by using two control boards, the communication apparatus operates while one of them serves as an active system and the other serves as a standby system. Note that each control board holds configuration information, which is information on various settings for controlling a communication apparatus.

Further, when a communication apparatus in which the control boards have a redundancy is powered on, two control boards start up simultaneously. In general, when two control boards start up simultaneously, the control board that will serve as the active system is determined according to the slot numbers that are assigned to the slots in which these boards are mounted.

### CITATION LIST

### Patent Literature

Patent literature 1: Japanese Unexamined Patent Application Publication No. 2006-261980

### SUMMARY OF INVENTION

### Technical Problem

However, there is a problem that when the communication apparatus is restarted after at least one of the redundant control boards is replaced, there is a possibility that the proper configuration information held by the control board that has not been replaced could be overwritten with the configuration information of the replacement control board.

For example, there is a case where: after the communication apparatus is temporarily powered off, the control board mounted in the slot having the lowest slot number (lower number) is replaced; and after that, the communication apparatus is started up, i.e., is powered on. In this case, since the control board having the lower number is determined as the active system as described above, the control board(s) mounted in the other slot(s) is synchronized based on the configuration information held by this operating-system control board. When the control board is replaced by a brand-new control board, its configuration information has not been defined yet. As a result, all the configuration information in the communication apparatus is initialized, thus creating a possibility that the communication apparatus cannot operate. Alternatively, when the control board is replaced by a second-hand control board, the original configuration information with which the communication apparatus has operated properly is overwritten with incorrect configuration information such as configuration information for a different apparatus. Therefore, there is a possibility that the communication apparatus may malfunction.

Note that although Patent literature 1 discloses a technique relating to a redundancy switching process, it cannot solve the above-described problem.

The present invention has been made to solve the above problem, and an object thereof is to provide a communication relay apparatus, an operation state determination method, a communication relay control board, and a control program for determining, when a communication including a plurality of redundant control boards mounted therein is restarted and hence the plurality of control boards are simultaneously started up, a control board with which the communication apparatus can continue the communication service in the same state as before the restart as an active system.

### Solution to Problem

A communication relay apparatus according to a first aspect of the present invention includes, in a redundant manner:

a first board that holds first configuration information including latest setting information in a communication service provided while the first board itself is mounted in a given communication relay apparatus, determines its own operation state upon start-up, and changes to the determined operation state; and

a second board that holds second configuration information including latest setting information in a communication service provided while the second board itself is mounted in a given communication relay apparatus, determines its own operation state upon start-up, and changes to the determined operation state, in which

each of the first and second boards determines, when neither of the first and second boards is faulty and they are simultaneously started up, its own operation state based on the first and second configuration information.

An operation state determination method according to a second aspect of the present invention includes:

determining an own operation state upon start-up, and recording first configuration information including latest setting information in a communication service provided while a first board is mounted in a given communication relay apparatus in the first board, the first board being to change to the determined operation state; and

determining an own operation state upon start-up, and recording second configuration information including latest setting information in a communication service provided while a second board is mounted in a given communication relay apparatus in the second board, the second board being to change to the determined operation state, in which

each of the first and second boards determines, when the first and second boards are mounted in the same communication relay apparatus in a redundant manner, and when neither of the first and second boards is faulty and they are simultaneously started up, the own operation state based on the first and second configuration information.

A communication relay control board according to a third aspect of the present invention includes:

a storage unit that stores first configuration information including latest setting information in a communication service provided while the communication relay control board itself is mounted in a given communication relay apparatus; and

an operation state control unit that determines an own operation state upon start-up and changes to the determined operation state, in which

when the communication relay control board itself and another board are mounted in the same communication relay apparatus in a redundant manner, and when neither of the communication relay control board itself and the another board is faulty and they are simultaneously started up,

the operation state control unit:

reads the first configuration information from the storage unit;

acquires second configuration information including latest setting information in a communication service from the another board, the communication service being provided while the another board is mounted in a given communication relay apparatus; and

determines the own operation state based on the first and second configuration information.

A recording medium according to a fourth aspect of the present invention stores a control program that causes a control device mounted in a first board to execute,

when the first board and a second board are mounted in the same communication relay apparatus in a redundant manner, and when neither of the first and second boards is faulty and they are simultaneously started up:

a process of reading first configuration information including latest setting information in a communication service from a storage device mounted in the first board, the communication service being provided while the first board is mounted in a given communication relay apparatus;

a process of acquiring second configuration information including latest setting information in a communication service from the second board, the communication service being provided while the second board is mounted in a given communication relay apparatus;

a determination process of determining the own operation state based on the first and second configuration information; and

a transition process of changing the first board to the determined operation state.

### Advantageous Effects of Invention

According to the present invention, it is possible to provide a communication relay apparatus, an operation state determination method, a communication relay control board, and a recording medium storing a control program for determining, when a communication apparatus including a plurality of redundant control boards mounted therein is restarted and hence the plurality of control boards are simultaneously started up, a control board with which the communication apparatus can continue the communication service in the same state as before the restart as an active system.

### BRIEF DESCRIPTION OF DRAWINGS

FIG. 1 is a block diagram showing a configuration of a communication relay apparatus according to a first exemplary embodiment of the present invention;

FIG. 2 is a flowchart showing an operation state determination process flow according to the first exemplary embodiment of the present invention;

FIG. 3 is a sequence diagram showing an operation state determination process flow according to the first exemplary embodiment of the present invention;

FIG. 4 is a block diagram showing an outline of a communication relay apparatus according to a second exemplary embodiment of the present invention;

FIG. 5 is a block diagram showing a main configuration of a communication relay apparatus according to the second exemplary embodiment of the present invention;

FIG. 6 is a table showing an example of operation states of a device control card according to the second exemplary embodiment of the present invention;

FIG. 7 is a flowchart for explaining an operation state determination process flow according to the second exemplary embodiment of the present invention;

FIG. 8 is a flowchart for explaining a priority determination process flow according to the second exemplary embodiment of the present invention;

FIG. 9 is a flowchart for explaining a simultaneous start-up operation of device control cards performed after one of them is replaced by a brand-new card according to the second exemplary embodiment of the present invention;

FIG. 10 is a flowchart for explaining a simultaneous start-up operation of device control cards performed after one of them is replaced by a second-hand card according to the second exemplary embodiment of the present invention;

FIG. 11 is a flowchart for explaining an operation state determination process flow according to a third exemplary embodiment of the present invention;

FIG. 12 is a flowchart for explaining an operation state determination process flow according to a fourth exemplary embodiment of the present invention; and

FIG. 13 is a flowchart for explaining an operation state determination process flow according to a fifth exemplary embodiment of the present invention.

### DESCRIPTION OF EMBODIMENTS

Specific exemplary embodiments to which the present invention is applied are explained hereinafter in detail with reference to the drawings. The same components are denoted by the same symbols throughout the drawings, and duplicated explanation is omitted as necessary for clarifying the explanation.

### First Exemplary Embodiment

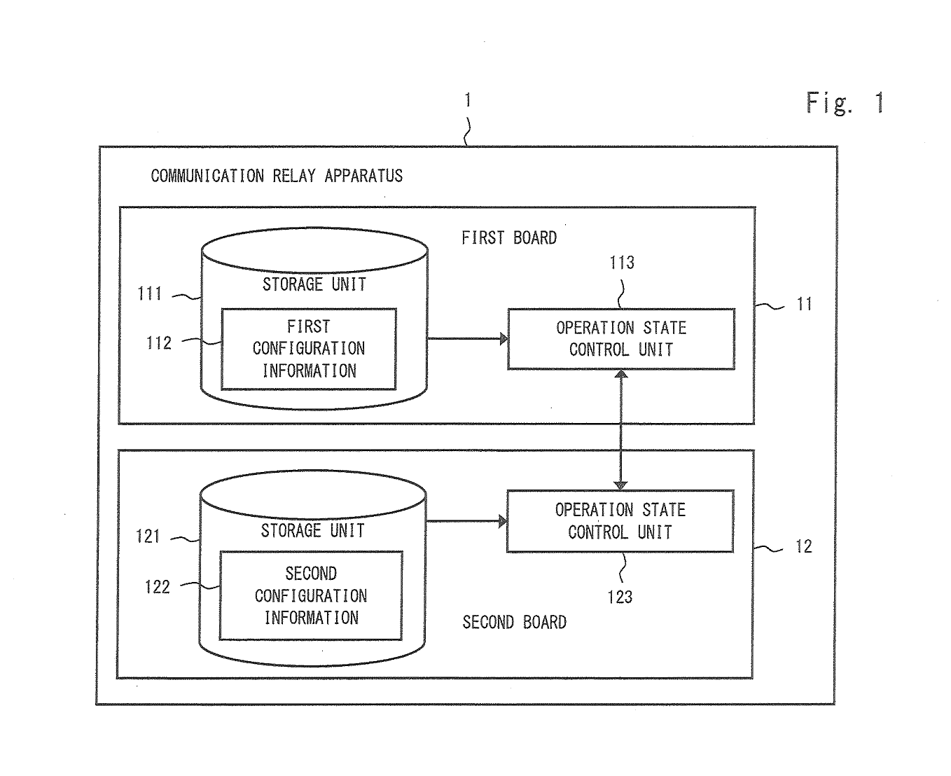

FIG. 1 is a block diagram showing a configuration of a communication relay apparatus 1 according to a first exemplary embodiment of the present invention. The communication relay apparatus 1 is an apparatus that relays communication data exchanged among a plurality of external communication base stations and communication terminals. For example, the communication relay apparatus 1 may be a microwave communication system (e.g., a communication system apparatus that links mobile phone base stations). Note that those microwave communication systems often support optical microwave communication, wireless communication, and so on.

The communication relay apparatus 1 includes at least a first board 11 and a second board 12. Each of the first and second boards 11 and 12 is a control board having a function of independently controlling a relay processing of communication data 14 performed in the communication relay apparatus 1. Further, the first and second boards 11 and 12 are mounted in the communication relay apparatus 1 in a redundant manner. Under normal circumstances, one of the boards operates as an active system and the other board operates as a standby system. Further, the number of control boards mounted in the communication relay apparatus 1 is not limited to two. That is, three or more control boards may be mounted. Note that the communication relay apparatus 1 includes other components/structures necessary for the above-described relay operation in addition to these components. However, since they are commonly known, their illustrations and explanations are omitted.

The first board 11 includes a storage unit 111 and an operation state control unit 113. The storage unit 111 is a storage device that holds first configuration information 112 including latest setting information in a communication service that has been provided while the first board 11 is mounted in a given communication relay apparatus. The operation state control unit 113 determines the operation state of the first board 11 upon start-up and changes to the determined operation state. For example, the operation state control unit 113 can be implemented by causing a CPU to read and execute FW (Firm-Ware), which is a computer program into which a communication relay control process is incorporated.

The second board 12 includes a storage unit 121 and an operation state control unit 123. The storage unit 121 is a storage device that holds second configuration information 122 including latest setting information in a communication service that has been provided while the second board 12 is mounted in a given communication relay apparatus. The operation state control unit 123 determines the operation state of the second board 12 upon start-up and changes to the determined operation state. Other components/configurations are similar to those of the first board 11.

That is, each of the first and second boards 11 and 12 can be mounted in an apparatus other than the communication relay apparatus 1. Further, the first and second configuration information 112 and 122 hold the first and second configuration information 112 and 122, respectively, including the final setting information of a communication service that has been provided in the latest operation. For example, there is a case where after the first board 11 had been mounted and operated in an apparatus other than the communication relay apparatus 1 in the past, the first board 11 is removed from the apparatus and mounted in the communication relay apparatus 1. In this case, when the first board 11 is mounted in the communication relay apparatus 1, the first configuration information 112 stored in the storage unit 111 includes setting information for a communication service that had been provided in the aforementioned apparatus other than the communication relay apparatus 1. To put it the other way around, the first configuration information 112 in this case does not have a guarantee to include correct setting information for the communication relay apparatus 1. Meanwhile, if the second board 12 has been mounted in the communication relay apparatus 1 most recently, the second configuration information 122 includes the most recent setting information of the communication relay apparatus 1 when the communication relay apparatus 1 is restarted.

When neither of the first and second boards 11 and 12 is faulty and they are simultaneously started up, the first board 11 determines the operation state of the first board 11, i.e., its own operation state based on the first and second configuration information 112 and 122. Further, when neither of the first and second boards 11 and 12 is faulty and they are simultaneously started up, the second board 12 determines the operation state of the second board 12, i.e., its own operation state based on the first and second configuration information 112 and 122.

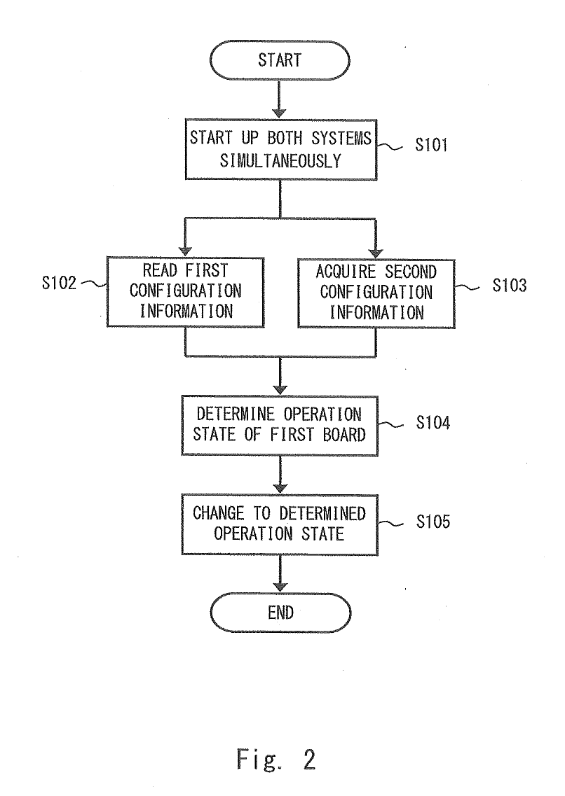

FIG. 2 is a flowchart showing an operation state determination process flow according to the first exemplary embodiment of the present invention. Although only the processes of the first board 11 are explained hereinafter as an example, the processes of the second board 12 are similar to them.

Firstly, in the communication relay apparatus 1, both the first and second boards 11 and 12 start up simultaneously (S 101). Examples of such situations include a case where the communication relay apparatus 1 is temporarily powered off and then powered on.

Next, the operation state control unit 113 reads the first configuration information 112 from the storage unit 111 (S 102). At the same time, the operation state control unit 113 acquires the second configuration information 122 from the operation state control unit 123 (S103). For example, the operation state control unit 113 transmits an acquisition request for the second configuration information 122 to the operation state control unit 123. Then, in response to this acquisition request, the operation state control unit 123 reads the second configuration information 122 from the storage unit 121 and sends back the read second configuration information 122 to the operation state control unit 113.

Then, the operation state control unit 113 determines the operation state of the first board 11 based on the first and second configuration informations 112 and 122 (S 104). After that, the operation state control unit 113 changes to the determined operation state (s105).

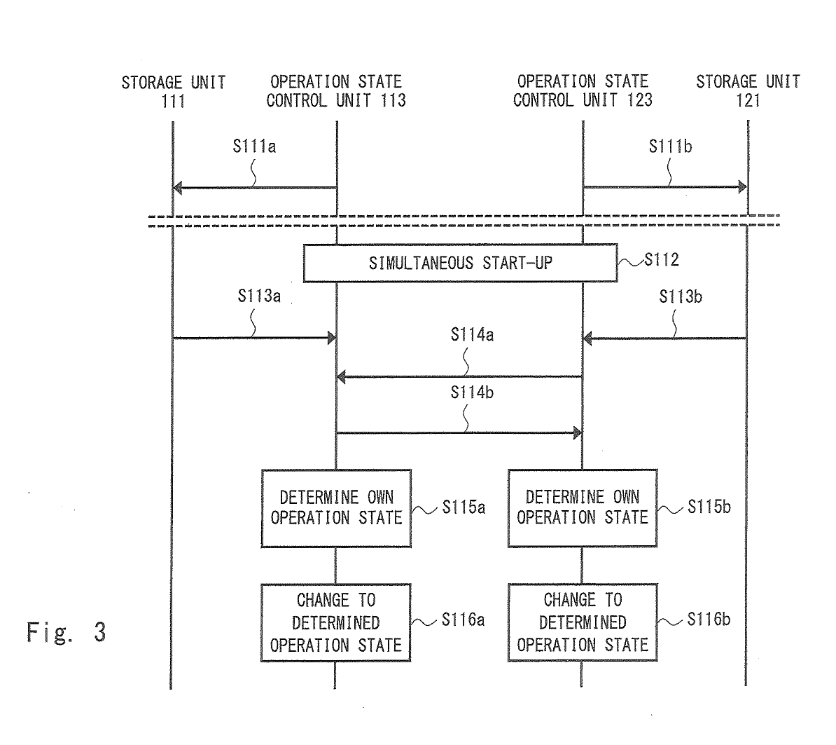

FIG. 3 is a sequence diagram showing an operation state determination process flow according to the first exemplary embodiment of the present invention. Firstly, the operation state control unit 113 records the first configuration information 112 in the storage unit 111 (S111a). Assume that at this point, the first board 11 is mounted in, for example, an apparatus other than the communication relay apparatus 1. In this case, the first configuration information 112 includes latest setting information in a communication service that has been provided while the first board 11 is mounted in the apparatus other than the communication relay apparatus 1.

Meanwhile, the operation state control unit 123 recodes the second configuration information 122 in the storage unit 121 (S111b). For example, when the second board 12 has been mounted in the communication relay apparatus 1, the second configuration information 122 includes latest setting information in a communication service that has been provided while the second board 12 is mounted in the communication relay apparatus 1. That is, in this state, the first and second boards 11 and 12 can provide the communication service in the communication relay apparatus 1 by using the second configuration information 122.

After that, for example, the communication relay apparatus 1 is powered off and the first board 11 is mounted in the communication relay apparatus 1. That is, the first and second boards 11 and 12 are mounted in the communication relay apparatus 1 in a redundant manner. Then, the communication relay apparatus 1 is powered on and the first and second boards 11 and 12 are started up simultaneously (S112). Assume that at this point, neither of the first and second boards 11 and 12 is faulty in terms of the hardware.

In this state, the operation state control unit 113 reads the first configuration information 112 from the storage unit 111 (S113a). Similarly, the operation state control unit 123 reads the second configuration information 122 from the storage unit 121 (S113b). Note that the order of the steps S113a and S113b does not matter.

Then, the operation state control unit 113 acquires the second configuration information 122 from the operation state control unit 123 (S114a). Similarly, the operation state control unit 123 acquires the first configuration information 112 from the operation state control unit 113 (S114b). Note that the order of the steps S114a and S114b does not matter. Further, one of the boards may incorporate its own configuration information into an acquisition request issued from that board, so that the other board may acquire the configuration information of the one board by receiving that acquisition request and may send back the configuration information of the other board as a reply to that acquisition request.

After that, the operation state control unit 113 determines its own operation state based on the first and second configuration information 112 and 122 (S115a). That is, the operation state control unit 113 determines the operation state of the first board 11. Then, the operation state control unit 113 changes to the determined operation state (S116a).

Similarly, the operation state control unit 123 determines its own operation state based on the first and second configuration information 112 and 122 (S115b). That is, the operation state control unit 123 determines the operation state of the second board 12. Then, the operation state control unit 123 changes to the determined operation state (S116b).

For example, even when the first board 11 had been mounted in an apparatus other than the communication relay apparatus 1 most recently and hence the first configuration information 112 includes the setting information of the apparatus other than the communication relay apparatus 1, the first and second boards 11 and 12 can determine that the second configuration information 122 is more suitable for the communication relay apparatus 1 by referring to the first and second configuration information 112 and 122 upon start-up. Therefore, the first board 11 can determine a standby system as its own operation state and the second board 12 can determine an active system as its own operation state. Accordingly, the first board 11 is synchronized by the second configuration information 122 including the latest setting information for providing the communication service in the communication relay apparatus 1. That is, the first configuration information 112 recorded in the storage unit 111 is overwritten with the second configuration information 122. Therefore, the restarted communication relay apparatus 1 can continue the communication service by the second configuration information 122, which is the correct setting information.

As described above, the first exemplary embodiment according to the present invention determines, when the communication apparatus including a plurality of redundant control boards mounted therein is restarted and hence the plurality of control boards are simultaneously started up, the control board with which the communication apparatus can continue the communication service in the same state as before the restart as the active system.

Note that at the point when the steps S111a and S111b are performed, the first board 11 may have been mounted in the communication relay apparatus 1 and the second board 12 may have been mounted in the apparatus other than the communication relay apparatus 1. Alternatively, both the first and second boards 11 and 12 may have been mounted in an apparatus(es) other than the communication relay apparatus 1. Further, both the first and second boards 11 and 12 may have been mounted in the communication relay apparatus 1.

### Second Exemplary Embodiment

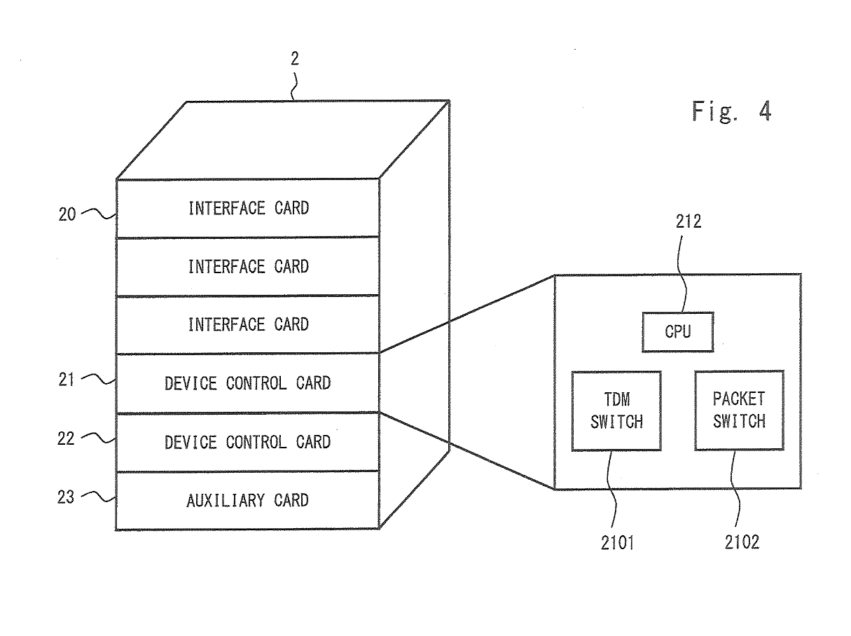

FIG. 4 is a block diagram showing an outline of a communication relay apparatus 2 according to a second exemplary embodiment of the present invention. For example, the communication relay apparatus 2 includes a plurality of slots disposed in the casing as shown in FIG. 4, and a card, which is a circuit board having a predetermined size and equipped with an input/output interface, can be removably mounted in each of the slots. In the case of FIG. 4, it is shown that a plurality of interface cards 20, device control cards 21 and 22, and an auxiliary card 23 and the like are mounted in the communication relay apparatus 2. Note that the number of the device control cards may be three or more. Further, assume that the device control card 21 includes, as an example, a CPU 212, a TDM Switch 2101, a Packet Switch 2102 and the like.

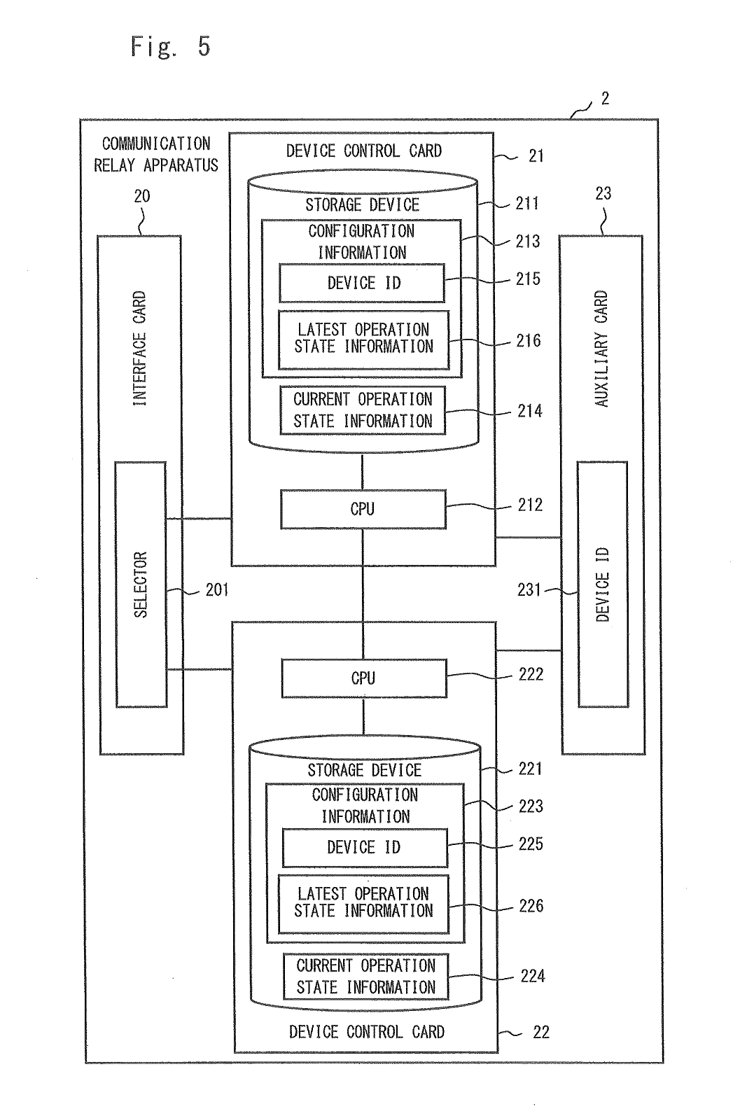

FIG. 5 is a block diagram showing a main configuration of the communication relay apparatus 2 according to the second exemplary embodiment of the present invention. The communication relay apparatus 2 is an apparatus that performs a communication relay of a time-division multiplexing all-packet network. The communication relay apparatus 2 includes the interface cards 20, the device control cards 21 and 22, and the auxiliary card 23. Note that the illustrations and explanations of commonly-known parts of the other configurations necessary for the communication relay apparatus are omitted.

The auxiliary card 23 performs communication with a device control terminal(s) that can connect to the communication relay apparatus 1. Further, the auxiliary card 23 is connected to each of the device control cards 21 and 22. The auxiliary card 23 is assigned a device ID 231 that makes it possible to uniquely identify the communication relay apparatus 1.

The interface card(s) 20 externally transmits/receives communication data. Further, the interface card 20 includes a selector 201. The selector 201 is connected to each of the device control cards 21 and 22 through a transmission line. Of the device control cards 21 and 22, the selector 201 communicates communication data with the board whose operation state is an active system. That is, the selector 201 selects one of the device control cards 21 and 22 and communicates the communication data to/from the selected board.

The device control card 21 is an embodiment of the first board 11 shown in FIG. 1. The device control card 21 includes a storage device 211 and a CPU 212. The storage device 211 is an embodiment of the storage unit 111 shown in FIG. 1. The storage device 211 stores configuration information 213 and current operation state information 214.

The configuration information 213 is an embodiment of the first configuration information 112 shown in FIG. 1. That is, the configuration information 213 includes latest setting information in a communication service that has been provided while the device control card 21 is mounted in a given communication relay apparatus. The configuration information 213 includes a device ID 215 and latest operation state information 216. Note that the configuration information 213 needs to include at least the device ID 215. The device ID 215 is device identification information that makes it possible to uniquely identify the apparatus in which the device control card 21 had been mounted most recently. For example, when the device control card 21 had been mounted in the communication relay apparatus 2 most recently, the device ID 215 is identical to the device ID 231 assigned to the auxiliary card 23. Further, when the device control card 21 had been mounted in a communication relay apparatus different from the communication relay apparatus 2 most recently and a communication service has been provided in that state, the device ID 215 is information that makes it possible to uniquely identify that different communication relay apparatus. Note that the configuration information 213 may include information about the last update time of the configuration information 213.

The latest operation state information 216 is information indicating the final operation state of the device control card 21 when the device control card 21 is mounted most recently. Further, the current operation state information 214 is information indicating the current operation state of the device control card 21.

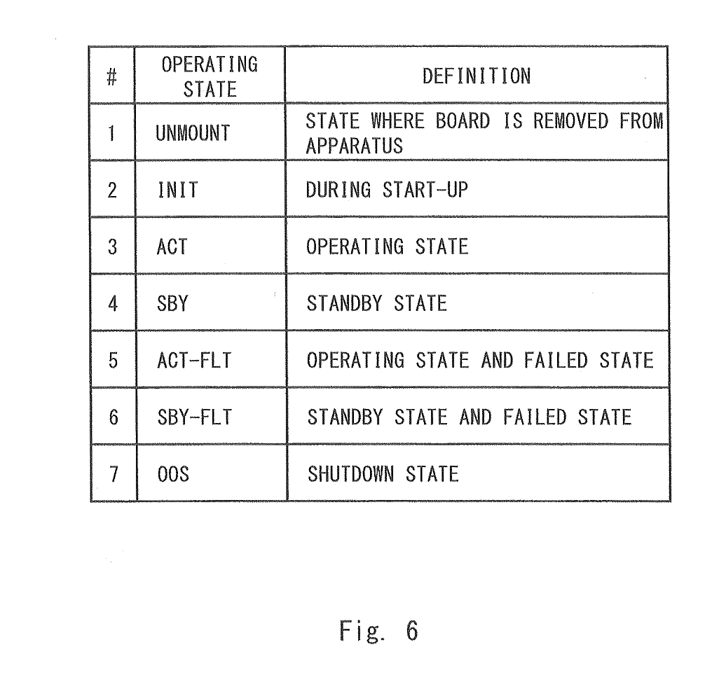

Here, FIG. 6 is a table showing an example of operation states of a device control card according to the second exemplary embodiment of the present invention. FIG. 6 shows, as an example of operation states, seven states including “UNMOUNT”, “INIT”, “ACT”, “SBY (StandBY)”, “ACT-FLT (FauLT)”, “SBY-FLT” and “OOS (Out Of Service)”. Note that the operation states are not limited to this example.

The CPU 212 is an embodiment of the operation state control unit 113 shown in FIG. 1. The CPU 212 reads and executes the above-described FW, and thereby performs a process for controlling a communication relay and a process for determining an operation state upon start-up.

The device control card 22 is an embodiment of the second board 12 shown in FIG. 1. The device control card 22 includes a storage device 221 and a CPU 222. The storage device 221 is an embodiment of the storage unit 121 shown in FIG. 1. The storage device 221 stores configuration information 223 and current operation state information 224. The configuration information 223 is an embodiment of the second configuration information 122 shown in FIG. 1. The configuration information 223 includes a device ID 225 and latest operation state information 226. Further, the storage device 221 and the CPU 222 have functions equivalent to those of the storage device 211 and the CPU 212. Further, the configuration information 223, the current operation state information 224, the device ID 225, and the latest operation state information 226 include contents equivalent to those of the configuration information 213, the current operation state information 214, the device ID 215, and the latest operation state information 216.

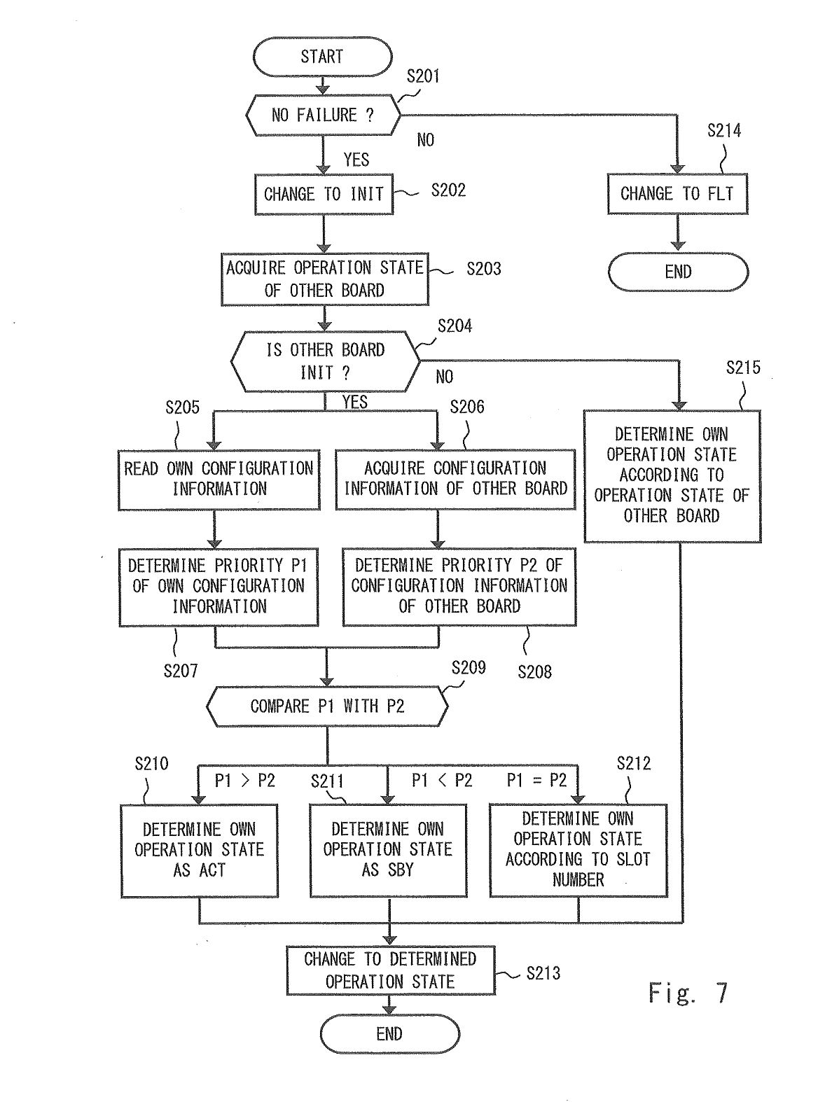

FIG. 7 is a flowchart for explaining an operation state determination process flow according to the second exemplary embodiment of the present invention. In the following explanation, only the processes for the device control card 21 that are performed upon start-up are explained as an example. However, the processes for the device control card 22 are similar to those of the device control card 21. Further, assume that the communication relay apparatus 2 includes the device control cards 21 and 22 mounted therein in a redundant manner.

Firstly, the CPU 212 of the device control card 21 verifies that there is no fault in the device control card 21 upon start-up (S201). If a fault is detected, the CPU 212 changes the operation state of the device control card 21 to an FLT state (S214). Note that a case where there is no fault is explained hereinafter.

Next, the CPU 212 changes the operation state of the device control card 21 to an INIT state (S202). For example, the CPU 212 sets the current operation state information 214 to “INIT” and updates the storage device 211. Then, the CPU 212 acquires the operation state of the other board (S203). For example, the CPU 212 transmits an acquisition request for the operation state to the CPU 222 of the device control card 22. Then, the CPU 222 reads the current operation state information 224 from the storage device 221 and sends back the read current operation state information to the CPU 212.

Then, the CPU 212 determines whether the other board is in an INIT state or not. For example, the CPU 212 refers to the current operation state information 224 of the device control card 22 acquired from the CPU 222, and thereby determines whether the other board is in an INIT state or not.

When the CPU 212 determines that the other board is not in the INIT state in the step S204, the CPU 212 determines its own operation state according to the operation state of the other board (S215). For example, when no other board is mounted in the communication relay apparatus 2, it means that only the device control card 21 is mounted in the communication relay apparatus 2. Therefore, the CPU 212 determines its own operation state as an ACT state. Further, when the operation state of the other board is an SBY state, the CPU 212 determines its own operation state as an OOS state. Further, when the operation state of the other board is an SBY-FLT state or an OOS state, the CPU 212 determines its own operation state as an ACT state. Further, when the operation state of the other board is an ACT-FLT state, the CPU 212 determines its own operation state as an ACT state after the CPU 212 synchronizes with the configuration information 223 of the other board. By doing so, the CPU 212 can take over and continue the communication service that has been provided by the other board.

When the CPU 212 determines that the other board is in the INIT state in the step S204, the CPU 212 reads its own configuration information (S205). Specifically, the CPU 212 reads the configuration information 213 from the storage device 211. At the same time, the CPU 212 acquires the configuration information of the other board (S206). Specifically, the CPU 212 transmits an acquisition request for the configuration information 223 to the CPU 222 of the device control card 22. Then, the CPU 222 reads the configuration information 223 from the storage device 221 and sends back the read configuration information to the CPU 212.

Then, the CPU 212 determines a priority P1 of its own configuration information (S207). Further, the CPU 212 determines a priority P2 of the configuration information of the other board (S208).

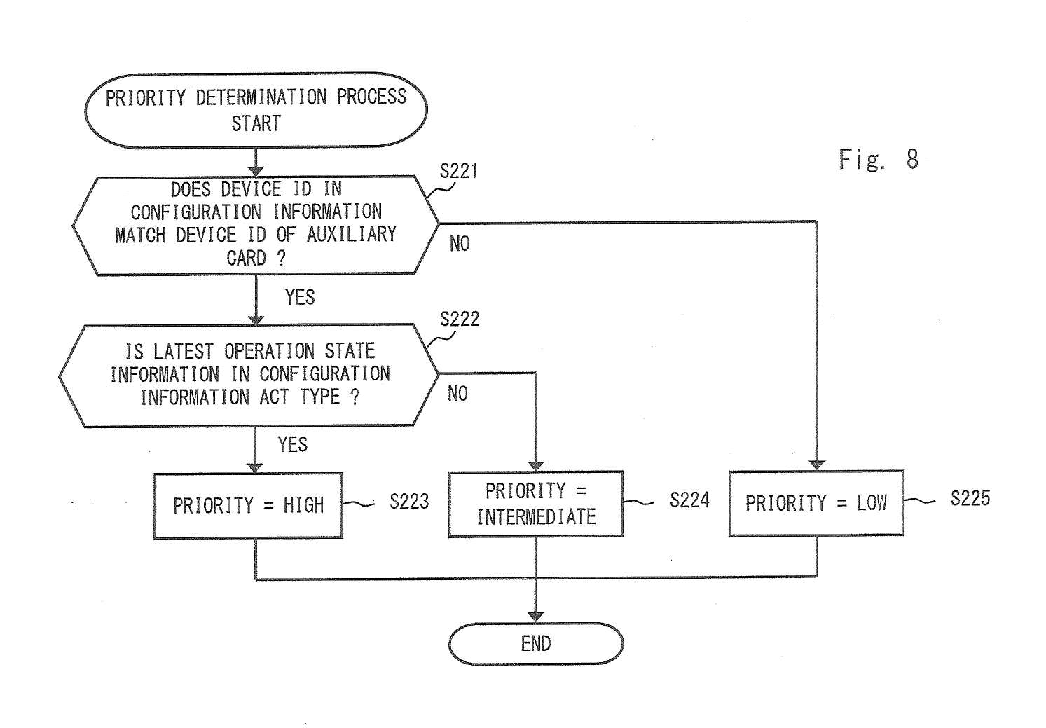

Here, FIG. 8 is a flowchart for explaining a priority determination process flow according to the second exemplary embodiment of the present invention. Although only the step S207 is explained hereinafter, the step S208 is similar to the step S207.

Firstly, the CPU 212 determines whether or not the device ID included in the configuration information matches the device ID of the auxiliary card (S221). For example, the CPU 212 compares the device ID included in the configuration information 213 with the device ID 231 acquired from the auxiliary card 23.

Then, when the CPU 212 determines that the device ID does not match, the CPU 212 determines that the priority of that configuration information is “low” (S225). The fact that the device ID does not match indicates that the apparatus in which the control card had been mounted most recently is not the communication relay apparatus 2. For example, there is a case where the device control card 21 is a brand-new card and hence its device ID 215 has not been defined yet, or a case where the device control card 21 is a second-hand card and hence its device ID 215 is a device ID of a different apparatus. In such cases, since the setting information included in the configuration information 213 is not suitable for the device control card 21, the priority is determined to be low.

In a step S221, when the CPU 212 determines that the device ID matches, the CPU 212 determines whether the latest operation state information included in the configuration information is an ACT type or not (S222). For example, the CPU 212 determines whether or not the latest operation state information 216 included in the configuration information 213 is either “ACT” or “ACT-FLT”.

When the CPU 212 determines that the latest operation state information is an ACT type, the CPU 212 determines that the priority of that configuration information is “high” (S223). On the other hand, when the CPU 212 determines that the latest operation state information is not an ACT type, the CPU 212 determines that the priority of that configuration information is “intermediate” (S224).

Referring to FIG. 7 again, the explanation is continued. Next, the CPU 212 compares the priority P1 with the priority P2 (S209). When P1 is greater than P2 (P1>P2), the CPU 212 determines its own operation state as an ACT state (S210). When P1 is smaller than P2 (P1<P2), the CPU 212 determines its own operation state as an SBY state (S211). When P1 is equal to P2 (P1=P2), the CPU 212 determines the own operation state according to the slot number (S211). For example, the CPU 212 may determine its own operation state as an ACT state when the device control card 21 is mounted in the lowest slot number, and may determine it as an SBY state in all the other cases.

After that, the CPU 212 changes to the operation state determined in the steps S210, S211, S212 and S215 (S213). For example, the CPU 212 sets the current operation state information 214 to the determined operation state and updates the storage device 211.

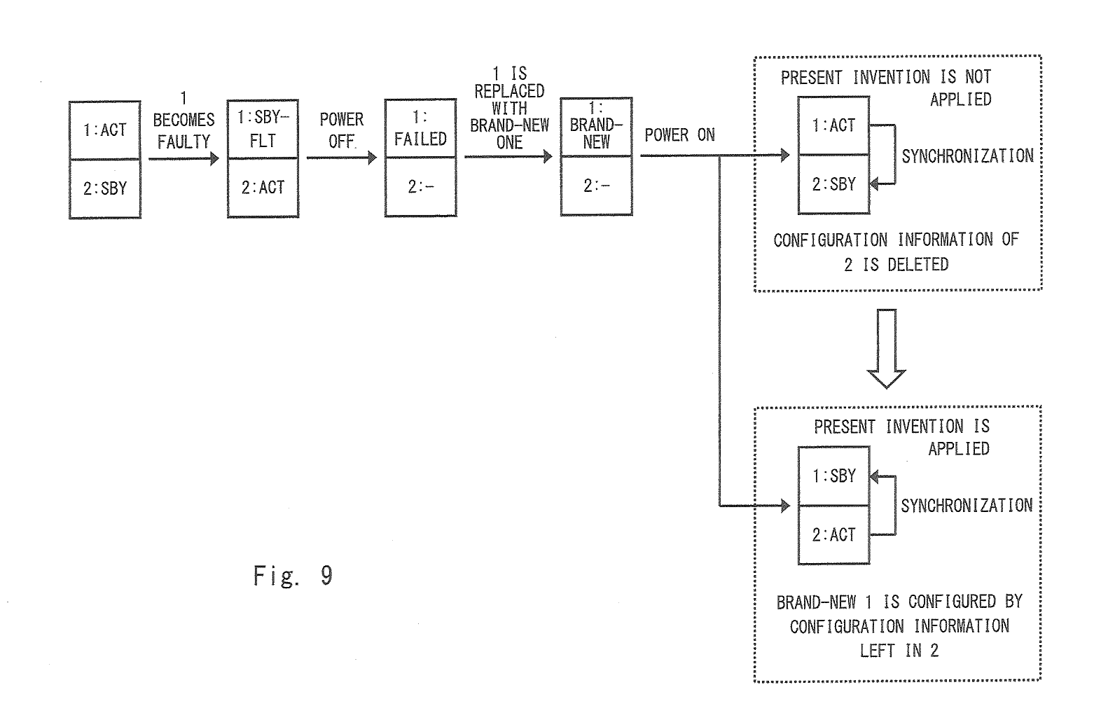

FIG. 9 is a flowchart for explaining a simultaneous start-up operation of device control cards that is performed after one of them is replaced by a brand-new card according to the second exemplary embodiment of the present invention. In this flowchart, it is shown that when the operation state of a first system is an ACT state and the operation state of a second system is an SBY state, the first system becomes faulty. Therefore, the first system changes to an SBY-FLT state and the second system changes to an ACT state, i.e., an active system. Further, it is shown that the communication relay apparatus 2 is powered off and the first-system board is replaced by a brand-new board.

After that, in the case where the present invention is not applied, when the communication relay apparatus 2 is powered on, the first system, which has the lowest slot number, becomes an ACT state and the second system is synchronized by the configuration information of the first system. That is, the configuration information of the second system is overwritten with the configuration information of the first system. Note that since the configuration information of the first system has not been defined yet, the configuration information of the second system is substantially deleted. That is, although the configuration information of the second system, which has been operating as an ACT system before the power-off, includes the latest correct setting information in the communication relay apparatus 2, the configuration information of the second system is deleted.

In contrast to this, in the case where the present invention is applied, when the communication relay apparatus 2 is powered on, the configuration information of the first system is compared with that of the second system and it is determined that the configuration information of the second system has a higher priority. Therefore, the second system becomes an ACT state and the first system is synchronized by the configuration information of the second system. That is, the latest correct setting information in the communication relay apparatus 2 is automatically set in the configuration information of the first system.

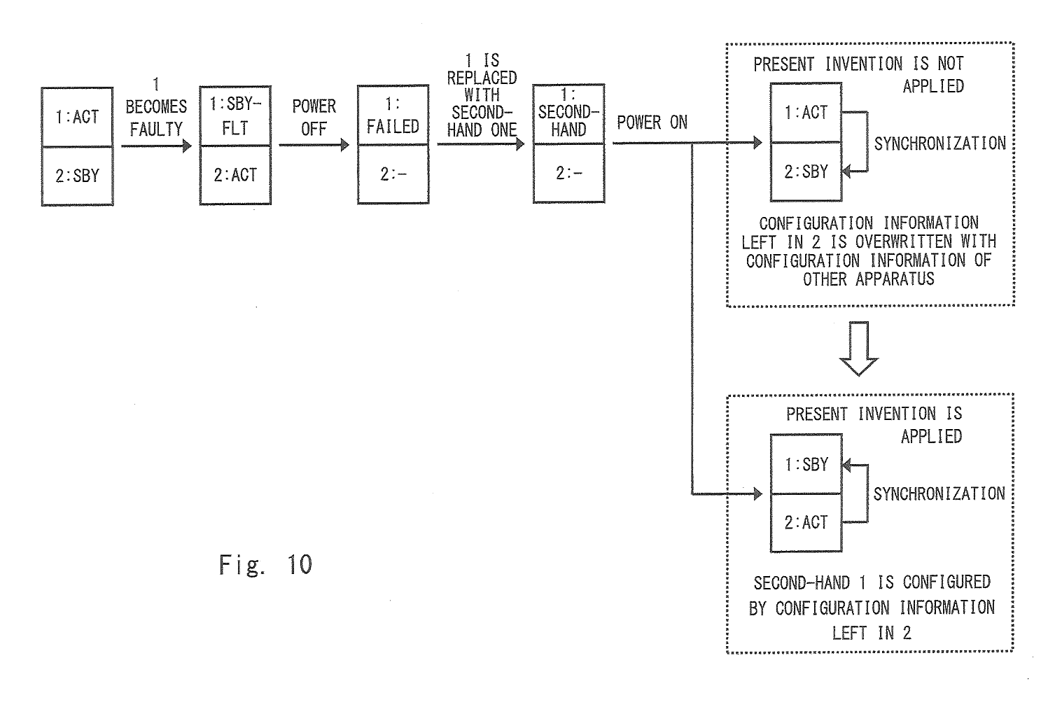

FIG. 10 is a flowchart for explaining a simultaneous start-up operation of device control cards performed after one of them is replaced by a second-hand card according to the second exemplary embodiment of the present invention. The difference between FIG. 10 and FIG. 9 is that the replacement board in FIG. 10 is a second-hand board. Therefore, there is a possibility that the configuration information of the first system includes the setting information for a different communication relay apparatus. As a result, in the case which the present invention is not applied, the configuration information of the second system is overwritten with the incorrect configuration information of the first system.

In contrast to this, in the case which the present invention is applied, since the device ID included in the configuration information of the first system is different from the device ID 231 of the auxiliary card 23, it is determined that the priority of the configuration information of the first system is lower than that of the second system. Therefore, the second system becomes an ACT state and the first system is synchronized by the configuration information of the second system. That is, the latest correct setting information in the communication relay apparatus 2 is automatically set in the configuration information of the first system. In this manner, according to the second exemplary embodiment of the present invention, it is possible to determine the control board with which the communication service can be continued in the same state as before the restart as the active system.

Examples of the features and advantageous effects in the second exemplary embodiments according to the present invention are explained hereinafter. Firstly, the configuration information 213 includes the device ID 215 that makes it possible to uniquely identify the apparatus in which the device control card 21 had been mounted most recently, and the configuration information 223 includes the device ID 225 that makes it possible to uniquely identify the apparatus in which the device control card 22 had been mounted most recently. Then, when the device ID 215 is different from the device ID 231 of the communication relay apparatus 2 in which the device control cards 21 and 22 are currently mounted and the device ID 225 matches the device ID 231, the device control card 21 determines its own operation state as a standby system and the device control card 22 determines its own operation state as an active system. As a result, it is possible to obtain synchronization by the correct configuration information even in the case shown in FIG. 9 or FIG. 10. Note that, needless to say, when the relation of the device IDs 215 and 225 is reversed, the operation states of the device control cards 21 and 22 are determined in a reversed fashion.

Further, the configuration information 213 further includes the latest operation state information 216, which is information about the final operation state of the device control card 21 when the device control card 21 had been mounted most recently, and the configuration information 223 further includes the latest operation state information 226, which is information about the final operation state of the device control card 22 when the device control card 22 had been mounted most recently. Then, each of the device control cards 21 and 22 determines its own operation state based on the latest operation state information 216 and 226 when the device IDs 215 and 225 match the device ID 231 of the communication relay apparatus 2 in which the device control cards 21 and 22 are currently mounted. That is, it is possible to determine whether the configuration information 213 or the configuration information 223 has a higher priority by the above-described priority determination process and thereby to determine the board holding that configuration information as the active system. Therefore, synchronization is obtained by the configuration information of the board that had been operating as the active system most recently. For example, it is also possible to cope with such a situation that the power is turned off before obtaining synchronization.

Note that the priority determination process according to the second exemplary embodiment of the present invention is not limited to the flow shown in FIG. 8. That is, the priority does not necessarily have to be divided into three levels shown below. That is, the only requirement is that at least the priorities of both systems can be determined by using the configuration information of both systems.

Further, the “priority” value does not necessarily have to be determined in the second exemplary embodiment according to the present invention. That is, the only requirement is that the communication relay apparatus includes the logic that makes it possible to determine at least which of the own board and the other board should become the active system by using the configuration informations of both systems, and that both systems independently make decisions based on the same logic.

### Third Exemplary Embodiment

In the above-described second exemplary embodiment according to the present invention, when the own board determines its own operation state as an SBY state, the other board has to determine its own operation state as an ACT state. However, when the other board cannot change to the ACT state for some reason, the resumption of the communication service after the restart is delayed. In addition, a situation where no operating-system board exists could occur. Therefore, in a third exemplary embodiment according to the present invention, even when the own board is determined to become an SBY state, if the other board has not changed to an ACT state within a certain time period, the own board becomes an ACT state on behalf of the other board. By doing so, the minimum communication service is maintained.

Note that the configuration of the communication relay apparatus according to the third exemplary embodiment of the present invention is equivalent to that shown in FIG. 5, and therefore its illustration and explanation are omitted. The following explanation is given with particular emphasis on the differences between the third exemplary embodiment and the second exemplary embodiment.

In the third exemplary embodiment according to the present invention, either one of the device control cards 21 and 22 determines its own operation state as a standby system (SBY) when the device ID 231 of the communication relay apparatus 2 in which the device control cards 21 and 22 are currently mounted matches the device IDs 215 or 225. Then, after that, when the other board has not changed to an active system within a certain time period, the device control cards 21 or 22 determines its own operation state as an active system (ACT) and changes the operation state of the other board to a standby system (SBY). Further, since there is a possibility that the other board, which is supposed to be changed to the active system under normal circumstances, has some kind of trouble, the own board changes the other board to a standby system in a forced manner and changes the own board itself to the active system on behalf of the other board, and thus making it possible to perform a more stable operation.

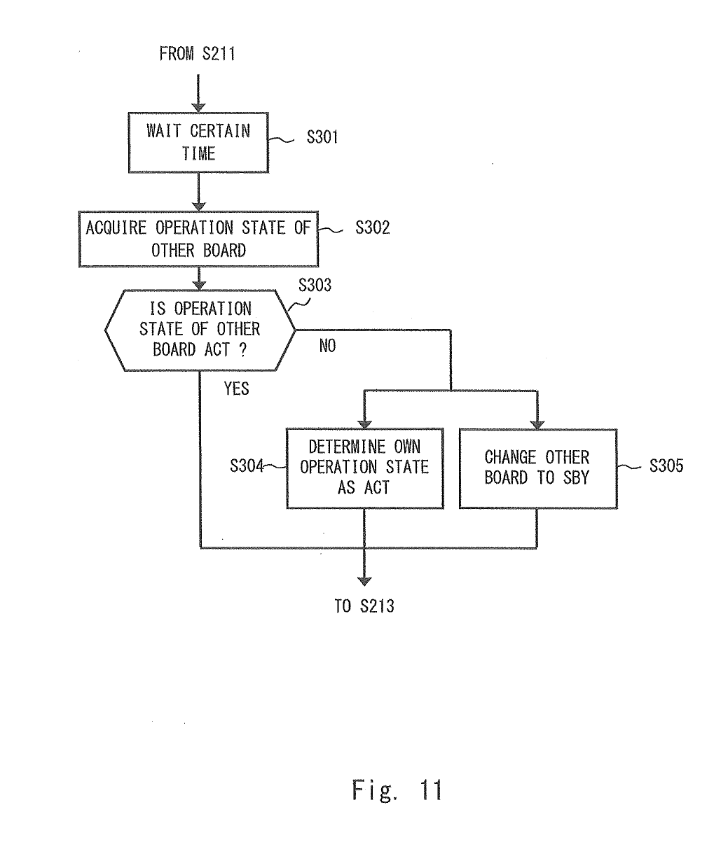

FIG. 11 is a flowchart for explaining an operation state determination process flow according to the third exemplary embodiment of the present invention. FIG. 11 shows processes subsequent to the step S211 shown in FIG. 7. That is, the CPU 212 has already determined its own operation state as an SBY state. After that, the CPU 212 waits a certain time period (S301). Then, the CPU 212 acquires the operation state of the other board (S302). For example, the CPU 212 acquires the current operation state information 224 from the configuration information 223 through a process similar to that in the step S203.

Next, the CPU 212 determines whether the operation state of the other board is an ACT state or not (S303). For example, the CPU 212 determines whether the current operation state information 224 is ACT or not. Then, when the CPU 212 determines that the operation state of the other board is an ACT state, it means that the communication service has already been resumed by the other board. Therefore, the process immediately proceeds to the step S213 shown in FIG. 7.

On the other hand, when the CPU 212 determines the operation state of the other board is not an ACT state in the step S303, the CPU 212 determines its own operation state as an ACT state (S304). At the same time, the CPU 212 changes the other board to an SBY state (S305). For example, the CPU 212 preferably transmits an operation state reset signal to the configuration information 223. This is performed to prevent the other board from changing to an ACT state after that. After that, the process proceeds to the step S213 shown in FIG. 7. In this manner, it is possible to make the communication relay apparatus 2 operate with higher stability and to resume the communication service earlier.

Note that the processes shown in FIG. 11 can also be applied to cases where the own operation state is determined as an SBY state in the step 212 in FIG. 7.

### Fourth Exemplary Embodiment

In the above-described second exemplary embodiment according to the present invention, when the operation state determination process functions properly in each board, no contradiction arises between the determined operation states. That is, the number of the active system is one. However, even if no fault is detected in the step S201 in FIG. 7, when there is some kind of trouble or when a trouble occurs during the operation state determination process, the operation state determination process does not necessarily function properly. Therefore, in the case where each board independently determines its own operation state, there is a possibility that a contradiction arises.

Accordingly, in a fourth exemplary embodiment of the present invention, it is checked whether there is any contradiction between the operation states determined by the respective boards before the state change. Then, if there is a contradiction, the board selected by a selector 201 is selected as the active system. That is, after each of the device control cards 21 and 22 has determined its own operation state, each device control card acquires the operation state determined in the other board. Then, if there is a contradiction between the operation states of the device control cards 21 and 22, they determine their operation states according to the board currently selected by the selector 201 of the interface card 20. In this manner, even when there is a contradiction between the operation state decisions in the respective boards due to an unexpected trouble (e.g., ACT and ACT, or SNY and SBY), signal down is less likely to occur since the board that is actually selected by the interface card 20 as the board to be communicated is given a higher priority, thus making it possible to continue the communication service.

Further, either one of the device control cards 21 and 22 determines, when that device control card itself is currently selected by the interface card 20, its operation state as an active system and changes the operation state of the other board to a standby system. This scheme makes it possible to perform the state change more reliably and to perform a more stable operation, because when there is a contradiction, there is a possibility that the other board cannot change to the standby system.

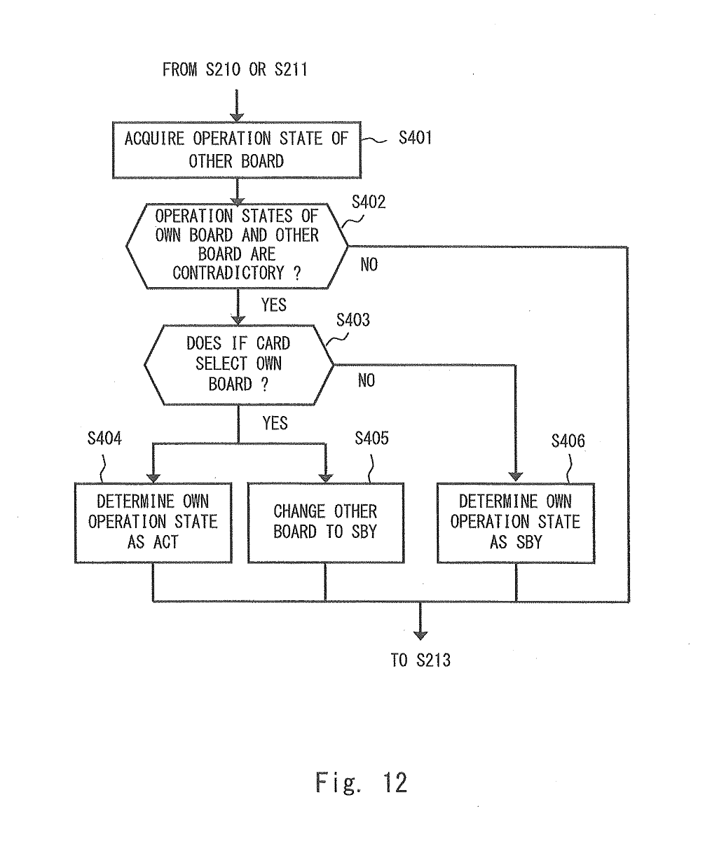

FIG. 12 is a flowchart for explaining an operation state determination process flow according to a fourth exemplary embodiment of the present invention. FIG. 12 shows processes subsequent to the steps S210 or S211 shown in FIG. 7. That is, the CPU 212 has already determined its own operation state as an ACT state or an SBY state. After that, the CPU 212 acquires the operation state of the other board as in the case of the step S203 in FIG. 7.

Next, the CPU 212 determines whether or not its own operation state contradicts that of the other board (S402). For example, the CPU 212 compares the operation state determined by the CPU 212 itself with that determined by the CPU 222 and thereby determines whether they contradict each other or not. Note that the contradiction between operation states means such cases where both the operation states are, for example, ACT types such as ACT and ACT-FLT, or where both of them are SBY types such as SBY and SBY-FLT.

In the step S402, when the CPU 212 determines that the operation states are contradictory, the CPU 212 determines whether or not the IF card selects the CPU 212 itself (S403). For example, the CPU 212 can determine whether the CPU 212 itself is selected or not based on the transmission line currently selected by the selector 201.

In the step S403, when the CPU 212 determines that the IF card selects the CPU 212 itself, the CPU 212 determines its own operation state as an ACT state (S404). At the same time, the CPU 212 changes the other board to an SBY state (S405). On the other hand, when the CPU 212 determines that the IF card does not select the CPU 212 itself, the CPU 212 determines its own operation state as an SBY state (S406).

The selector 201 of the interface card 20 selects a board for which an ACT signal indicating the validity/invalidity of the transmission line connected to each board is an on-state. Therefore, this means that the selector 201 selects the board that can actually provide the communication service. However, in the case of immediately after the start-up, in order to eliminate the brand-new and second-hand boards, it is necessary, without fail, to give a higher priority to the operation state determination based on the configuration information through the processes in the steps S201 to S212 shown in FIG. 7. Therefore, in the fourth exemplary embodiment according to the present invention, the process shown in FIG. 12 is used in a supplemental manner after the step S210 or S211. By doing so, it is possible to resume the communication service more reliably.

In the fourth exemplary embodiment according to the present invention, each of the device control cards 21 and 22 may determine its own operation state by taking account of a communication history held by the interface card 20 as well. Since the interface card 20 holds the communication history up to the latest operation, it is possible to determine the board that had served as the active system most recently without causing any trouble as an active system based on this communication history in a preferential manner. Consequently, it is possible to improve the stability even further.

### Fifth Exemplary Embodiment

In the step S212 in FIG. 7, when the priorities of configuration information are equal to each other, the operation states are determined according to the slot numbers. In this case, when a certain board which was mounted in the communication relay apparatus 2 in the past and whose latest operation state information 216 was an ACT state is removed from the communication relay apparatus 2 and then mounted in the slot 1 again after a certain time has elapsed, its priority could become “high” because the device ID 215 matches the device ID 231 and the latest operation state information 216 is the ACT state. Further, the priority of the board which has been already mounted in the slot 2 most recently and whose latest operation state information 226 is ACT could also become “high”. In this case, since the priorities are equal, the board that has been mounted in the slot 1 again is determined as the active system. However, in this case, the configuration information held by the board in the slot 2 is newer and more correct.

Therefore, in a fifth exemplary embodiment according to the present invention, each of the device control cards 21 and 22 determines the priority, which is the priority level as the active system, for each of the device control cards 21 and 22 based on the configuration information 213 and 214. Then, when the priorities of the device control cards 21 and 22 are equal to each other, they determine that the board currently selected by the interface card 20 has a higher priority and they each determine their own operation state according to the determined priority. In this manner, even in the above-described case, since the board selected by the interface card 20 is the board in the slot 2, the synchronization can be obtained by using newer and more correct configuration information.

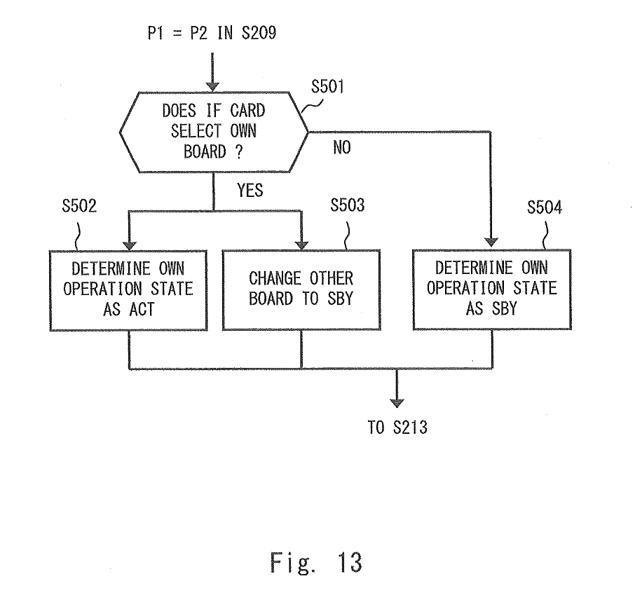

FIG. 13 is a flowchart for explaining an operation state determination process flow according to the fifth exemplary embodiment of the present invention. FIG. 13 shows a process that substitutes for the step S212 in FIG. 7. That is, when P1 is equal to P2 (P1=P2) in the step S209 in FIG. 7, steps S501 to S504 are performed. Note that the steps S501 to S504 are processes equivalent to the steps S403 to S406 shown in FIG. 12. Therefore, their detailed explanation is omitted.

### Other Exemplary Embodiments

Note that in the case described in the fifth exemplary embodiment, the priority determination process shown in FIG. 8 can be improved by using the configuration shown below. That is, the configuration information 213 further includes information about the last update time of the configuration information 213, and the configuration information 223 further includes information about the last update time of the configuration information 223. Then, each of the device control cards 21 and 22 determines its own operation state based on the last update time(s) when the device IDs 215 and 225 match the device ID 231 of the communication relay apparatus 2 in which the device control cards 21 and 22 are currently mounted. In this manner, even when a board that was mounted as ACT in the same apparatus as that in the past but has old setting information is mounted again, it is possible to give a higher priority to a board having the most recent setting information even when it is in a SBY state.

Further, the present invention is not limited to the above-described exemplary embodiments, and needless to say, various modifications can be made without departing from the spirit and scope of the present invention described above. For example, although the present invention is described as a hardware configuration in the above-described exemplary embodiments, the present invention is not limited to the hardware configurations. In the present invention, arbitrary processing can be also implemented by causing a CPU (Central Processing Unit) to execute a computer program.

In the above-described examples, the program can be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), a CD-R, and a CD-R/W, a DVD (Digital Versatile Disc), a BD (Blu-ray (registered trademark) Disc), and a semiconductor memory (such as a mask ROM, a PROM (Programmable ROM), an EPROM (Erasable PROM), a flash ROM, and a RAM (Random Access Memory)). Further, the program can be supplied to computers by using various types of transitory computer readable media. Examples of the transitory computer readable media include an electrical signal, an optical signal, and an electromagnetic wave. The transitory computer readable media can be used to supply programs to computer through a wire communication path such as an electrical wire and an optical fiber, or wireless communication path.

Note that the present invention is not limited to the above-described exemplary embodiments, and various modifications can be made as desired without departing the spirit and scope of the present invention. For example, the communication relay apparatus 2 does not necessarily have to store the device ID 231, which makes it possible to uniquely identify the communication relay apparatus 2, in the auxiliary card 23. The communication relay apparatus 2 may store the device ID 231 in a given storage device which can be accessed from the device control cards 21 and 22. Further, needless to say, the present invention can have a configuration that is obtained by combining processes according to the above-described exemplary embodiments as desired.

This application is based upon and claims the benefit of priority from Japanese patent application No. 2011-237986, filed on Oct. 28, 2011, the disclosure of which is incorporated herein in its entirety by reference.

### INDUSTRIAL APPLICABILITY

The present invention is useful as a radio communication apparatus in which when a communication apparatus on a transmission side cannot directly communicate with a communication apparatus on a reception side, a relay apparatus relays and transmits a signal(s) between these communication apparatuses.

### REFERENCE SIGNS LIST

1 COMMUNICATION RELAY APPARATUS
11 FIRST BOARD
111 STORAGE UNIT
112 FIRST CONFIGURATION INFORMATION
113 OPERATION STATE CONTROL UNIT
12 SECOND BOARD
121 STORAGE UNIT
122 SECOND CONFIGURATION INFORMATION
123 OPERATION STATE CONTROL UNIT
2 COMMUNICATION RELAY APPARATUS
20 INTERFACE CARD
201 SELECTOR
21 DEVICE CONTROL CARD
2101 TDM Switch
2102 Packet Switch
211 STORAGE DEVICE
212 CPU
213 CONFIGURATION INFORMATION
214 CURRENT OPERATION STATE INFORMATION
215 DEVICE ID
216 LATEST OPERATION STATE INFORMATION
22 DEVICE CONTROL CARD
221 STORAGE DEVICE
222 CPU
223 CONFIGURATION INFORMATION
224 CURRENT OPERATION STATE INFORMATION
225 DEVICE ID
226 LATEST OPERATION STATE INFORMATION
23 AUXILIARY CARD
231 DEVICE ID

1. A communication relay apparatus comprising, in a redundant manner:
a first board that holds first configuration information including latest setting information in a communication service provided while the first board itself is mounted in a given communication relay apparatus, determines its own operation state upon start-up, and changes to the determined operation state; and
a second board that holds second configuration information including latest setting information in a communication service provided while the second board itself is mounted in a given communication relay apparatus, determines its own operation state upon start-up, and changes to the determined operation state, wherein
each of the first and second boards determines, when neither of the first and second boards is faulty and they are simultaneously started up, the own operation state based on the first and second configuration information.

2. The communication relay apparatus according to claim 1, wherein
the first configuration information includes first device identification information that makes it possible to uniquely identify an apparatus in which the first board is mounted most recently,
the second configuration information includes second device identification information that makes it possible to uniquely identify an apparatus in which the second board is mounted most recently, and
when the first device identification information is different from device identification information of a communication relay apparatus in which the first and second boards are currently mounted and the second device identification information matches that device identification information of the communication relay apparatus, the first board determines the own operation state as a standby system and the second board determines the own operation state as an operating system.

3. The communication relay apparatus according to claim 2, wherein
the first configuration information further includes first latest operation state information, the first latest operation state information being information about a final operation state of the first board when the first board had been mounted most recently,
the second configuration information further includes second latest operation state information, the second latest operation state information being information about a final operation state of the second board when the second board had been mounted most recently, and
each of the first and second boards determines the own operation state based on the first and second latest operation state information when device identification information of a communication relay apparatus in which the first and second boards are currently mounted matches the first and second device identification information.

4. The communication relay apparatus according to claim 2, wherein
the first configuration information further includes information about a last update time of the first configuration information,
the second configuration information further includes information about a last update time of the second configuration information, and
each of the first and second boards determines the own operation state based on the last update time when device identification information of the communication relay apparatus in which the first and second boards are currently mounted matches the first and second device identification information.

5. The communication relay apparatus according to claim 3, wherein when device identification information of the communication relay apparatus in which the first and second boards are currently mounted matches the first and second device identification information and either one of the first and second boards determines the own operation state as a standby state, but after that the operation state of the other board has not changed to an operating state within a certain time period, that board determines the own operation state as an operating state and changes the operation state of the other board to a standby state.

6. The communication relay apparatus according to claims 3, further comprising an interface unit that externally transmits/receives communication data, selects either one of the first and second boards, and communicates that communication data with the selected board, wherein
each of the first and second boards:
determines the own operation state and then acquires the operation state determined in the other board; and
when the operation states of the first and second boards are contradictory, determines the own operation state according to the board currently selected by the interface unit.

7. The communication relay apparatus according to claim 6, wherein either one of the first and second boards determines, when the interface unit currently selects the own board, the own operation state as an operating state and changes the operation state of the other board to a standby state.

8. The communication relay apparatus according to claims 3, further comprising an interface unit that externally transmits/receives communication data, selects either one of the first and second boards, and communicates that communication data with the selected board, wherein
each of the first and second boards:
determines a priority for each of the first and second boards based on the first and second configuration information, the priority being a priority level as an operating system;
when the priorities of the first and second boards are equal to each other, determines that the board currently selected by the interface unit has a higher priority; and
determines the own operation state according to the determined priority.

9. The communication relay apparatus according to claims 6, wherein each of the first and second boards determines the own operation state by taking account of a communication history held by the interface unit as well.

10. An operation state determination method comprising:
determining an own operation state upon start-up, and recording first configuration information including latest setting information in a communication service provided while a first board is mounted in a given communication relay apparatus in the first board, the first board being to change to the determined operation state; and
determining an own operation state upon start-up, and recording second configuration information including latest setting information in a communication service provided while a second board is mounted in a given communication relay apparatus in the second board, the second board being to change to the determined operation state, wherein
each of the first and second boards determines, when the first and second boards are mounted in the same communication relay apparatus in a redundant manner, and when neither of the first and second boards is faulty and they are simultaneously started up, the own operation state based on the first and second configuration information.

11. A communication relay control board comprising:
a storage unit that stores first configuration information including latest setting information in a communication service provided while the communication relay control board itself is mounted in a given communication relay apparatus; and
an operation state control unit that determines an own operation state upon start-up and changes to the determined operation state, wherein
when the communication relay control board itself and another board are mounted in the same communication relay apparatus in a redundant manner, and when neither of the communication relay control board itself and the another board is faulty and they are simultaneously started up,
the operation state control unit:
reads the first configuration information from the storage unit;
acquires second configuration information including latest setting information in a communication service from the another board, the communication service being provided while the another board is mounted in a given communication relay apparatus; and
determines the own operation state based on the first and second configuration information.

12. A non-transitory computer readable medium that stores a control program for causing a control device mounted in a first board to execute,
when the first board and a second board are mounted in the same communication relay apparatus in a redundant manner, and when neither of the first and second boards is faulty and they are simultaneously started up;
a process of reading first configuration information including latest setting information in a communication service from a storage device mounted in the first board, the communication service being provided while the first board is mounted in a given communication relay apparatus;
a process of acquiring second configuration information including latest setting information in a communication service from the second board, the communication service being provided while the second board is mounted in a given communication relay apparatus;
a determination process of determining an operation state of the first board based on the first and second configuration information; and
a transition process of changing the first board to the determined operation state.
